(19) United States
(12) Patent Application Publication
(10) Pub. No.: US 2010/0214119 A1
(43) Pub. Date: Aug. 26, 2010

(54) METHOD AND DEVICE FOR ASSIGNING ADDRESSES IN A SYSTEM HAVING A PLURALITY OF GENERATOR UNITS POSITIONED IN PARALLEL

(76) Inventors: Thomas Peuser, Ludwigsburg (DE); Helmut Suelzle, Freiberg (DE)

Correspondence Address: KENYON & KENYON LLP, ONE BROADWAY, NEW YORK, NY, 10004, US

(21) Appl. No.: 12/160,922

(22) PCT Filed: Jan. 12, 2007
(86) PCT No.: PCT/EP2007/050303

§ 371 Date: Apr. 20, 2010

(30) Foreign Application Priority Data
Jan. 16, 2006 (DE) 10 2006 001 983.0

(51) Int. Cl. H02J 13/00; H02J 1/10

(52) U.S. Cl. 340/825.52; 307/9.1

(57) ABSTRACT

The present invention relates to a method and a device for assigning addresses in a system having a plurality of generator units connected in parallel. After receiving a start signal, the first generator unit assigns itself an individual address and outputs an identification signal at its control-signal output. Each of the further generator units receives an identification signal output at the control-signal output of a generator unit upstream of it, and assigns itself an individual address as a function of the identification signal received in each case.

The present invention relates to a method and a device for assigning addresses in a system having a plurality of generator units positioned in parallel relative to each other. For example, in a motor vehicle, the supply voltage may be provided for the loads of the electrical system by generator units connected in parallel in this way.

### BACKGROUND INFORMATION

It is already known to power the electrical system of a motor vehicle using a generator.

Moreover, it is already known to supply the electrical system of certain vehicles, e.g., safety vehicles, ambulances and commercial vehicles, with energy using at least two generators, in order to be able to ensure the required power demand and/or the required reliability of the electrical supply.

The wear, and therefore also the service life of a generator depends on several factors. One of these factors is its electrical capacity utilization. The greater the electrical capacity utilization of a generator, the greater its wear and the lower its remaining service life. Therefore, it is desirable to be able to control the capacity utilization of the generators used according to strategies specification to the application. For example, application-specific strategies are a uniform capacity utilization or a very one-sided distribution of the capacity utilization.

The German Patent 10 2005 12 270.1 describes a method and a device for providing the supply voltage for the loads of a vehicle electrical system, using several generators. A regulating unit having at least one power transistor is assigned to each of the generators. In order to bring the degree of capacity utilization of the generators into agreement, in one of the regulating units, a pulse-width-modulated control signal or a control signal derived from it and describing the pulse duty factor of the pulse-width-modulated signal is formed and supplied to the power transistors of all regulating units.

Moreover, a device having generators connected in parallel is described in the German Patent 41 08 861 A1. In this known device, a voltage regulator is assigned to each of the generators. The known device also has at least one battery whose one terminal is connectable to the voltage regulator via an ignition switch. Furthermore, a charge-indicator device is provided which is connected to the ignition switch and the voltage regulators, and is connectable via a circuit element to the negative terminal of the battery preferably connected to ground. Between the charge-indicator device, the voltage regulators and the indicated circuit element is a circuit configuration having a plurality of components conductive in one direction and blocking in one direction. To be achieved by this known device is that a high electrical power can be produced by the use of two generators, and that faults occurring in one of the two generator/voltage-regulator systems can be indicated by a single indicator, e.g., a charge-indicator lamp, while the other generator/voltage-regulator system can continue working without problem.

### SUMMARY OF THE INVENTION

In contrast, a method having the features set forth in claim 1 and a device having the features set forth in claim 6 have the advantage that the individual generator units belonging to the overall system each have their own individual address. They are able to be differentiated based on this separate individual address, and are able to be accessed individually if necessary. This individual addressing may be accomplished by a control unit which is connected to the generator units via a data bus. For example, the control unit directs a diagnostic query to one of the generator units. It responds to the control unit by sending data relevant for the diagnostics back to it, together with the individual address.

One special advantage of the present invention is that no external coding nor any external wiring which, for example, would already have to be predetermined when configuring the circuitry, are needed for assigning addresses. In the present invention, after receiving a start signal, the generator units themselves in each case automatically assign themselves an individual address. This is accomplished in that the first generator unit, after receiving a start signal and a control signal s3 applied to its control-signal input, assigns to itself an individual address and outputs a first identification signal at its control-signal output, and each of the other generator units receives an identification signal output at the control-signal output of a generator unit upstream of it, and assigns itself an individual address as a function of the respective identification signal received.

One easy to realize embodiment provides for supplying a predefined voltage level as control signal s3 to the control-signal input of the first generator unit.

Based on this predefined voltage level, which is supplied exclusively to the first generator unit, the first generator unit recognizes that it has the task of taking on the master function within the framework of the parallel operation of the generator units. Moreover, after receiving the predefined voltage level, the first generator unit assigns itself its individual address.

According to the features delineated in claims 4 and 5, the generator units each transmit their individual address via a data bus to a control unit. This may take place automatically after the respective generator unit or after all generator units have assigned themselves their individual address. Alternatively, after a predefined time span has elapsed since the occurrence of the start signal, the control unit may automatically output a query signal via the data bus, which the generator units receive and respond to accordingly.

If, by this transmission of addresses, the control unit knows how many generator units are available for the parallel operation and which address is assigned to each of these generator units, then during later operation, the control unit is able to use this knowledge to address each of the generator units individually via the data bus and to transmit queries or commands to the respective generator unit or retrieve data from the respective generator unit.

Further advantageous characteristics of the present invention are yielded from their exemplary clarification with reference to the figure.

### BRIEF DESCRIPTION OF THE DRAWING

FIG. 1 shows a block diagram for explaining the assigning of addresses according to the present invention.

FIG. 2 shows a detailed representation of first generator unit 1 of FIG. 1.

### DESCRIPTION

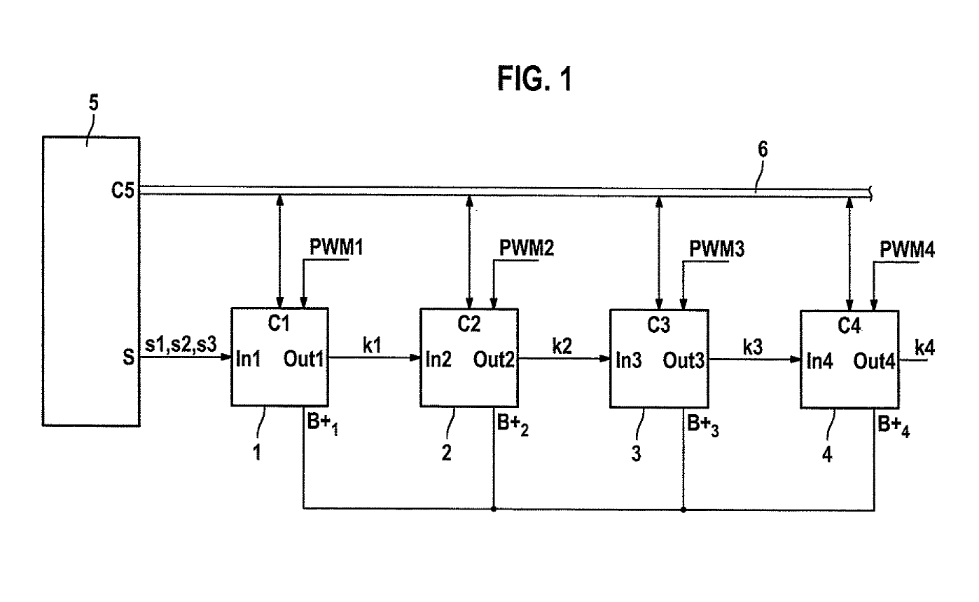

FIG. 1 shows a block diagram for explaining the assigning of addresses according to the present invention.

This block diagram includes a first generator unit 1, a second generator unit 2, a third generator unit 3 and a fourth generator unit 4. These generator units are connected in parallel to each other in terms of their function, which is to make a DC supply voltage available for the loads of a vehicle electrical system.

A pulse-width modulated drive signal PWM1 is fed to first generator unit 1, a pulse-width modulated drive signal PWM2 is fed to second generator unit 2, a pulse-width modulated drive signal PWM3 is fed to third generator unit 3, and a pulse-width modulated drive signal PWM4 is fed to fourth generator unit 4. These pulse-width modulated signals, which are made available by a signal source not shown in FIG. 1, are converted by a controller of the respective generator unit into generator control signals and fed to the generator of the respective generator unit.

As a function of the generator control signal fed to it, this generator makes available at its output, an actual voltage value which is present in the form of a positive supply voltage at the voltage-supply output of the respective generator unit.

As evident from FIG. 1, positive supply voltages B+₁, B+₂, B+₃ and B+₄ are available at the voltage-supply outputs of the generator units. Since these voltage-supply outputs are interconnected, the total supply voltage made available is combined from the supply voltages provided by generator units 1, 2, 3 and 4. This parallel connection of a plurality of generator units ensures that the power requirement demanded during operation and the required reliability of the voltage supply exist for the loads of a vehicle electrical system.

During operation of the device shown in FIG. 1, wear of the generator units or generators occurs. For this reason, it is very important to monitor the individual generators in order to have information available about the condition of the generators. This information includes, for example, that a generator has failed, that a temperature above normal exists, that a generator is no longer rotating, etc. When necessary, based on this information, a generator may be replaced in order to continue to ensure the desired voltage supply.

For the purpose of this monitoring or diagnostics, query signals are fed by a control unit 5 via its data interface C5 and a data bus 6 to the individual generator units during the parallel operation. As response to these query signals, the respective generator unit transmits data illustrating the condition of the generator of the respective generator unit to the control unit via data bus 6.

During this transmission of the query signals to the respective generator unit and during the transmission of the data describing the generator condition, the useful data indicated are transmitted together with an individual address which specifies the specific generator unit, and therefore the specific generator, as well.

In the present invention, these individual addresses of the generator units are stipulated or assigned as follows:

After a starting procedure, a start signal s1 is output by a start-signal transmitter, which is control unit 5 in the exemplary embodiment shown in FIG. 1. For example, a starting procedure takes place after each new start of the engine and also after each reset of the system as carried out, for example, after the occurrence of a malfunction.

In the exemplary embodiment shown, start signal s1 is output at an output S of control unit 5.

This start signal s1 is supplied to a control-signal input In1 of first generator unit 1. The controller of this generator unit 1 recognizes the presence of start signal s1 and checks as to whether an address-assigning start signal s2 and a predefined control signal s3 are being supplied to it via control-signal input In1. For example, control signal s3 is a specific voltage level. If address-assigning start signal s2 and control signal s3 are present, the controller then assigns to itself, that is, assigns to first generator unit 1 an individual address, e.g., the address “1”. Furthermore, based on control signal s3, it recognizes that it is to perform master functions for the following parallel operation of the generators. Moreover, it makes an identification signal k1 available at a control-signal output Out1 of first generator unit 1.

This identification signal k1 contains information to the effect that it comes from a generator unit which has assigned to itself the address “1”, and is applied to control-signal input In2 of second generator unit 2. The controller of this second generator unit 2 recognizes the presence of identification signal k1 and assigns to itself, that is, assigns to second generator unit 2 an individual address, e.g., the address “2”. Furthermore, based on identification signal k1, it recognizes that it is to assume the slave function for the following parallel operation of the generators. Moreover, it makes an identification signal k2 available at a control-signal output Out2 of second generator unit 2.

This identification signal k2 contains information to the effect that it comes from a generator unit which has assigned to itself the address “2”, and is applied to control-signal input In3 of third generator unit 3. The controller of this third generator unit recognizes the presence of identification signal k2 and assigns to itself, that is, assigns to third generator unit 3 an individual address, e.g., the address “3”. Furthermore, based on identification signal k2, it recognizes that it is to assume the slave function for the following parallel operation of the generators. Moreover, it makes an identification signal k3 available at a control-signal output Out3 of third generator unit 3.

This identification signal k3 contains information to the effect that it comes from a generator unit which has assigned to itself the address “3”, and is applied to control-signal input In4 of fourth generator unit 4. The controller of this fourth generator unit recognizes the presence of identification signal k3 and assigns to itself, that is, assigns to fourth generator unit 4 an individual address, e.g., the address “4”. Furthermore, based on identification signal k3, it recognizes that it is to assume the slave function for the following parallel operation of the generators. Moreover, it makes an identification signal k4 available at a control-signal output Out4 of fourth generator unit 4.

These addresses of the generator units are transmitted from the respective generator unit via its respective data interface C1, C2, C3, C4 and data bus 6 to control unit 5 and stored there.

The addresses may be transmitted automatically from the generator units to control unit 5 when the respective generator unit has assigned itself its individual address, or when all the generator units have assigned themselves their individual address. Alternatively, it is also possible, after a predefined time span has elapsed since the occurrence of the start signal, for control unit 5 to send out query signals via the data bus, to which the generator units react in order to signal to the control unit that they are available and what address they have in each case.

The reassignment of addresses after each start of the engine and after each system reset also has the advantage of a flexible parallel operation. For example, in the course of service work, one of the generator units may be removed. This removal is recognized during the next reassignment of addresses, since only three generator units respond with address signals to the control unit. Care must only be taken that the generator units form a series connection with respect to their control-signal inputs and outputs, which must not be interrupted. For example, in the event third generator unit 3 is removed, control-signal output Out2 of second generator unit 2 must be connected to control-signal input In4 of fourth generator unit 4.

Moreover, in the course of service work, an additional generator unit may also be added. This addition is recognized during the next reassignment of addresses, since now five generator units respond with address signals to the control unit. Care must only be taken that the generator units form a series connection with respect to their control-signal inputs and outputs, which must not be interrupted. For example, when adding on a fifth generator unit, care must be taken that control-signal output Out4 of fourth generator unit 4 is connected to the control-signal input of the fifth generator unit.

In the exemplary embodiment described above, start signal si and address-assigning start signal s2 were made available at an output S of control unit 5. According to another specific embodiment not shown in FIG. 1, start signal si may also be provided by a different start-signal transmitter and supplied to first generator unit 1 via its data interface C1. In the same way, address-assigning start signal s2 may also be supplied to first generator unit 1 via data interface C1.

In the exemplary embodiment described above, at the instant of the output of the start signal, at control-signal outputs Out1, Out2, Out3 and Out4 a low-level signal is present. Alternatively, at the instant of the output of the start signal, at control-signal outputs Out1, Out2, Out3 and Out4 a different signal may also be present which, however, must be distinguishable from control signal s3.

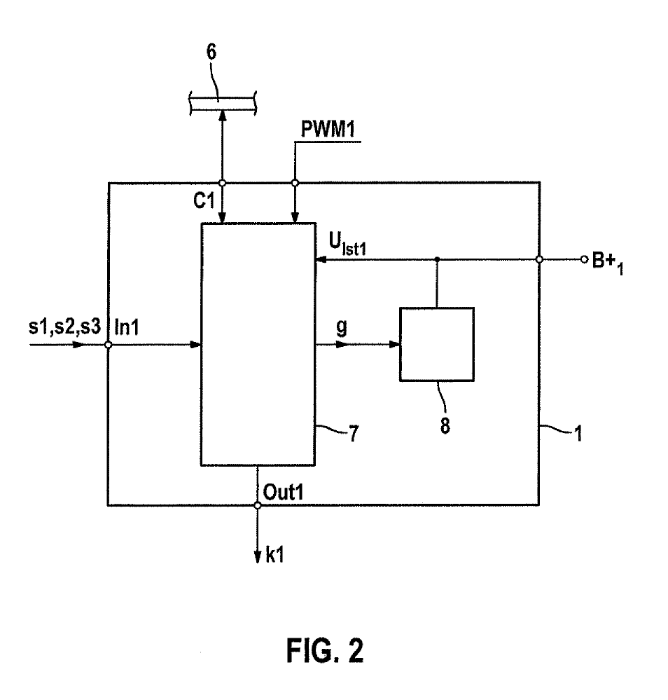

FIG. 2 shows a detailed representation of first generator unit 1 of FIG. 1.

Generator unit 1 has a controller 7 and a generator 8. Controller 7 is realized in the form of an integrated circuit or is set up in the form of a circuit having discrete components.

Start signal s1, address-assigning start signal s2 and control signal s3 applied to control-signal input In1 of generator unit 1 are supplied as input signals to controller 7. During later parallel operation, pulse-width-modulated drive signals PWM1 are supplied to controller 7. Controller 7—prompted by start signal si and address-assigning start signal s2 and with the aid of control signal s3 applied to control-signal input

In1—identifies itself, that is, identifies generator unit 1 as master and assigns itself an individual address. Furthermore, it generates identification signal k1 and makes it available at control-signal output Out1 of first generator unit 1. In addition, the address which the controller has assigned to itself, that is, to generator unit 1, is transmitted via data interface C1 and data bus 6 to the control unit.

Moreover, during later parallel operation, query signals from the control unit are transmitted to controller 7 via data interface C1, and the diagnostic data requested by the control unit are transmitted from controller 7 via data interface C1 and data bus 6 to the control unit.

In addition, during later parallel operation, controller 7 provides generator control signals g to generator 8. As reaction to these generator control signals g, the generator provides an actual DC-voltage value U_{Act1} at an output. It is fed back to controller 7 and used there along the lines of a control process for ascertaining new generator control signals g. The actual DC-voltage value is also made available as positive DC supply voltage B+₁ at an output of the first generator unit.

Moreover, in parallel operation, at one of its terminals, preferably via its terminal Out1, controller 7 outputs a signal that describes the degree of capacity utilization of generator 8.

The design of generator units 2, 3 and 4 corresponds with the design of generator unit 1, so that in the case of the exemplary embodiment shown, four generator units of the same design connected in parallel contribute to the provision of the DC supply voltage for the loads of a motor-vehicle electrical system.

These generator units each assign themselves an individual address after each starting procedure. In so doing, initially the first generator unit assigns itself an individual address and outputs a first identification signal at its control-signal output. Each of the further generator units receives an identification signal output at the control-signal output of a generator unit upstream of it and, as reaction to the receipt of this identification signal, assigns itself an individual address as a function of the respective identification signal.

In the exemplary embodiment described above, four generator units connected in parallel contribute to the provision of the DC supply voltage. Alternatively, a total of 2, 3, 5, 6 or even a greater number of generator units connected in parallel may also be used to provide the desired DC supply voltage.

In the exemplary embodiment described above, in each case the identification signal contains information as to what generator unit it comes from, and the controller of the generator unit receiving the identification signal assigns itself an individual address which differs from the identification signal received, e.g., a next-higher number.

According to an alternative specific embodiment, the identification signal contains information as to what address the generator control unit receiving the identification signal should have. In this case, the controller of the generator control unit receiving the identification signal assigns to itself, that is, assigns to the generator unit receiving the identification signal the address predefined by the generator control unit outputting the identification signal, and on its part, makes available at the output a new identification signal which contains information as to what address the generator control signal receiving the new identification signal should have.

In the exemplary embodiment described above, in parallel operation, pulse-width-modulated control signals are in each case fed to the generator units via a separate input. Alternatively, it is also possible to perform the address assignment described above during an initialization phase, and after the initialization phase has ended, to alter the function of the control-signal inputs and control-signal outputs for the subsequent parallel operation. Thus, in parallel operation, generator unit 1 is able to output a pulse-width-modulated control signal at its control-signal output Out1. All other generator units receive this signal at their control-signal inputs, and output it again, unchanged, at their control-signal outputs. The degree of capacity utilization of the generators is thereby able to be brought into agreement.

Furthermore, in the exemplary embodiment described above, signals s1 and s2 are signals which occur at different instants. According to another specific embodiment of the present invention, there is only a single start signal, which is used as start signal and at the same time as address-assigning start signal.

1-11. (canceled)

12. A method for assigning addresses in a system including a first generator unit and at least one further generator unit positioned in parallel to the first generator unit, each of the generator units having a control-signal input and a control-signal output, and the control-signal input of each further generator unit being connected in each case to the control-signal output of another of the generator units, comprising:
after receiving a start signal, assigning the first generator unit an individual address to itself based on a control signal applied to the control-signal input of the first generator unit and outputting a first identification signal at the control-signal output of the first generator unit; and
receiving by each further generator unit an identification signal output at the control-signal output of an upstream generator unit and assigning each further generator unit to itself an individual address as a function of the identification signal received.

13. the method according to claim 12, wherein the control signal supplied to the control-signal input of the first generator unit has a predefined voltage level.

14. the method according to claim 12, wherein after receiving the control signal, the first generator unit identifies itself as master for a parallel operation of the generator units.

15. the method according to claim 12, wherein the generator units transmit an individual address via a data bus to a control unit.

16. the method according to claim 15, wherein, after receiving a query signal output by the control unit, the generator units transmit the individual address via the data bus to the control unit.

17. A device, comprising
a first generator unit;
at least one further generator unit positioned in parallel to the first generator unit;
wherein each generator unit includes a control-signal input, a control-signal output, and a data interface; and
wherein each of the control-signal inputs of the further generator units is connected to the control-signal output of an upstream generator unit.

18. The device according to claim 17, further comprising a data bus to which the data interfaces of the generator units are connected.

19. The device according to claim 18, wherein the data interfaces of the generator units are connected via the data bus to a control unit.

20. The device according to claim 19, wherein the generator units each have a controller and a generator, self-assignment of an individual address is performed by the controller of the respective generator unit, and the controller is provided to transmit the individual address via the data bus to the control unit.

21. The device according to claim 20, wherein the controller is provided to transmit the individual address via the data bus to the control unit after receiving a query signal output by the control unit.

22. The device according to claim 17, wherein the generator units connected in parallel are configured to make the supply voltage available for loads of a vehicle electrical system.

23. The device according to claim 17, wherein the device is configured to perform the method recited in claim 12.
